(19) United States
(12) Patent Application Publication
(10) Pub. No.: US 2006/0242589 A1
(43) Pub. Date: Oct. 26, 2006

(54) System and method for remote examination services

(76) Inventors: Rod Cooper, Southlake, TX (US); Ed Hohn, Daingerfield, TX (US)

Correspondence Address: SLATER & MATSIL, L.L.P., 17950 PRESTON RD, SUITE 1000, DALLAS, TX, 75252-5793, US

(21) Appl. No.: 11/114,676

(22) Filed: Apr. 26, 2005

(51) Int. Cl. G06F 17/00; G06F 3/00; G06F 9/00

(52) U.S. Cl. 715/753

(57) ABSTRACT

A system and method for providing remote examination services is provided. The system includes a control system communicatively coupled to a document viewing system, audio-receiving devices, and a video imaging system. The control system may also be communicatively coupled to a network such that remote systems can participate in the examination. The control system can be configured to access a document, mark the document as an exhibit, and display the document on the document viewing system. The document can be highlighted by users of the control system, the document viewing system, and/or a remote system. Modifications (e.g., highlighting) to the document made with one system are preferably reflected in the display of the other systems.

### TECHNICAL FIELD

The present invention relates generally to remote communications services and, more particularly, to a system and method for providing remote examination services.

### BACKGROUND

Generally, meetings are typically conducted by two or more participants meeting at a predetermined location to discuss a specific issue. When the participants are located at the same facility, gathering the participants at a single location may be effective and efficient. On the other hand, if the participants are located at different facilities, particularly different cities, the costs in terms of time and money can be prohibitive to all of the participants traveling to meet at a single location.

To help reduce the costs involved with traveling to a single location, participants may participate in a meeting via a teleconference. In many instances, however, this is not sufficient and it is necessary to visually witness the participants and the items being discussed. For example, a deposition typically involves one or more attorneys questioning a deponent about certain facts and events relevant to the underlying litigation. During questioning, it is helpful to visually witness the deponent's demeanor as the deponent is responding to questions.

One attempt to solve this problem involves conducting depositions at a first location while allowing other individuals to participate from a remote location. This attempt involves using a first camera and a first microphone at a first location with the deponent and an attorney, and a second camera and a second microphone at a second location with other participants (i.e., other attorneys). The other attorneys at the remote location are then able to hear the questions posed to the deponent while witnessing the deponent's demeanor.

This attempt, however, fails to provide a mechanism for viewing documents and other exhibits from the remote locations. Many depositions typically involve questioning the deponent on specific documents and/or other exhibits. The attorney and/or the deponent may reference specific sections of the documents. In order for the remote participants to fully participate and to fully understand the question and answer, it is often necessary for the remote participants to see the exhibits being discussed, which is not available with the system described above.

Hence, there is a need for a system and method to conduct or participate in examinations from remote locations.

### SUMMARY OF THE INVENTION

These and other problems are generally solved or circumvented, and technical advantages are generally achieved, by preferred embodiments of the present invention which provides a system and method for providing remote examination services.

In accordance with an embodiment of the present invention, a method of providing remote examination services is provided. The method comprises communicatively coupling a first network device to a network and communicatively coupling a first display and a second display to the first network device such that the first network device may display information on the first display and the second display. A video imaging system may be communicatively coupled to the first network device such that the first network device may transmit video from the video imaging system over the network, and an audio-receiving device may be communicatively coupled to the first network device such that the first network device may transmit audio from the audio-receiving device over the network. A second network device may be communicatively coupled to the network at a remote location from the first network device, thereby providing remote access to remote examination. A document may be selected to view/highlight on at least the first display and the second display, audio detected by the audio-receiving device may be transmitted to the remote location, and video from the video imaging system may be transmitted to the remote location.

In accordance with another embodiment of the present invention, a system for providing remote examination services is provided. The system comprises a first display, a second display, a video imaging system to generate video signals, an audio-receiving device to generate audio signals, a remote network device communicatively coupled to a network, the remote network device having a third display, and a local network device communicatively coupled to the first display, the second display, the video imaging system, and the audio-receiving device. The local network device is communicatively coupled to the network and configured to display a selected document on the first display and the second display. The local network device is further configured to transmit to the remote network device the audio signals, the video signals, and an image presented on the first display.

It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The following is a brief description of the drawings, which illustrate exemplary embodiments of the present invention and in which:

FIG. 1 is a system diagram in accordance with an embodiment of the present invention;

FIG. 2 illustrates an example of a screen interface that may be used in accordance with an embodiment of the present invention; and

FIG. 3 is a block diagram of a control system in accordance with an embodiment of the present invention.

### DETAILED DESCRIPTION OF ILLUSTRATIVE EMBODIMENTS

Referring now to the drawings, wherein like reference numbers are used herein to designate like or similar elements throughout the various views, illustrative embodiments of the present invention are shown and described. The figures are not necessarily drawn to scale, and in some instances the drawings have been exaggerated and/or simplified in places for illustrative purposes only. One of ordinary skill in the art will appreciate the many possible applications and variations of the present invention based on the following illustrative embodiments of the present invention.

The present invention will be described with respect to preferred embodiments in a specific context, namely, conducting a deposition wherein the deposition may be viewed remotely. In this embodiment, remote viewers may further communicate with a person (e.g., an attorney conducting the deposition) located locally. Embodiments of the present invention, however, may be applied to other situations. For example, embodiments of the present invention may be useful in conducting interviews, examinations, or any other situation in which it would be useful for a plurality of individuals to witness and/or partake in the questioning of and/or discussion with one or more individuals.

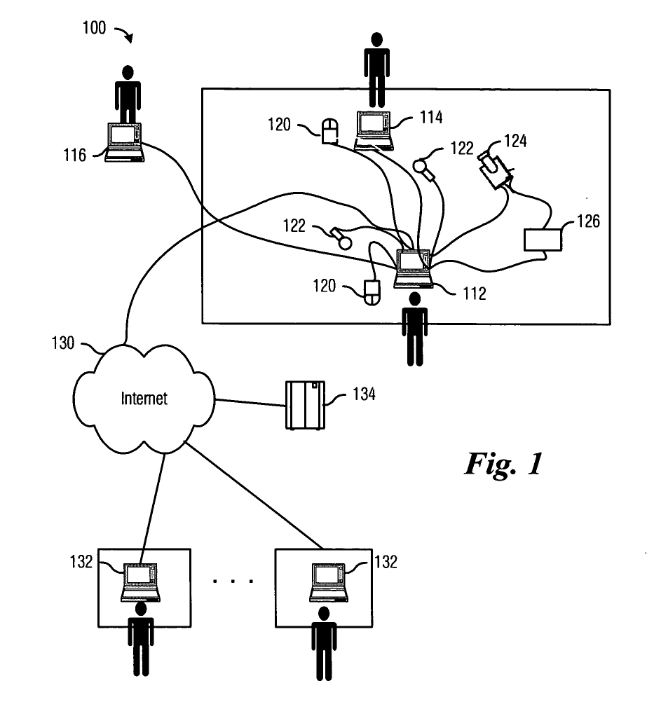

Referring now to FIG. 1, reference numeral 100 designates a network diagram embodying features of an embodiment of the present invention. It should be noted that one of ordinary skill in the art will realize that the network diagram 100 has been simplified to better illustrate features of the present invention. Well-known elements have not been shown, but are nonetheless part of a network embodying features of the present invention. For example, a network embodying the present invention may include power supplies, maintenance systems, gateways, routers, firewalls, and the like.

The network diagram 100 comprises a control system 112 communicatively coupled to one or more document-viewing systems 114 and a stenography system 116. The control system 112 may also be communicatively coupled to one or more indicator devices 120, audio-receiving devices 122, and/or video imaging devices 124. In a preferred embodiment, the control system 112 is communicatively coupled to a network 130, thereby providing electronic access to one or more remote systems 132. The network 130 may also provide access to a server 134.

The control system 112 may comprise a general purpose computing device, such as a personal computer (PC), a mini-computer, a main frame, a personal data assistant, a laptop computer, a tablet PC, or the like configured to provide a graphical display to a user. The control system 112 may execute, for example, an operating system such as Microsoft Windows, provided by Microsoft Corporation of Redmond, Wash., Mac OS provided by Apple Computer, Inc., of Cupertino, Calif., an open-source UNIX OS, or the like. It should be noted that these systems are depicted as separate and distinct systems for illustrative purposes only.

In a preferred embodiment, the stenography system 116 comprises a general purpose computing device configured to communicatively couple to a stenography machine, wherein the general purpose computing device is configured with software and/or hardware that converts the shorthand entered on the stenography machine to text. The stenography system 116 may execute, for example, an operating system such as Microsoft Windows, provided by Microsoft Corporation of Redmond, Wash., Mac OS provided by Apple Computer, Inc., of Cupertino, Calif., an open-source UNIX OS, or the like. The stenography system 116 may comprise a stenography machine designed to enable a user to efficiently enter shorthand as the examination process is conducted. One such system that may be used to convert shorthand to text is CaseView provided by Stenograph, L.L.C., of Mount Prospect, Ill.

It should be noted that the stenography system 116 and the control system 112 are depicted as separate and distinct systems for illustrative purposes only. In some embodiments, these systems or portions of these systems may be incorporated into a single unit. For example, in an embodiment the stenography system 116 may comprise a stenography machine coupled directly to the control system 112, wherein the control system is configured to convert shorthand to text. Similarly, each of the stenography system 116 and the control system 112 may be separated into two or more units.

The document-viewing system 114 may be a general purpose computing device, such as a personal computer (PC), a mini-computer, a main frame, a personal data assistant, a laptop computer, a tablet PC, or the like configured to provide a graphical display to a user. The document-viewing system 114 may execute, for example, an operating system such as Microsoft Windows, provided by Microsoft Corporation of Redmond, Wash., Mac OS provided by Apple Computer, Inc., of Cupertino, Calif., an open-source UNIX OS, or the like. In these embodiments, however, it may be desirable to limit the capabilities of the general purpose computing device such that a user of the document-viewing system 114 has only viewing and/or designating capabilities in response to questioning and/or the underlying discussion. In a preferred embodiment, the document-viewing system 114 is a graphical display, such as a cathode-ray tube (CRT), a flat-panel display, or the like communicatively coupled to the control system 112, wherein the control system 112 controls the information displayed on the document-viewing system 114.

The indicator devices 120 may be any device that allows a user to point to or otherwise indicate/select an object presented on the display of the document-viewing system 114 and/or the control system 112. Examples of devices that may act as indicator devices 120 include a mouse, a light-pen, a touch-screen, a keyboard, or the like. Preferably, an indicator device 120 is provided for the control system 112 and each of the document viewing systems 114. One or more of the indicator devices 120 may be incorporated into the control system 112 and/or the document-viewing system 114.

As discussed above, the control system 112 may be communicatively coupled to the network 130 such that remote systems 132, which are communicatively coupled to the network 130, may communicate and partake in the examination/questioning process. The network 130 may be a local-area network (LAN), a wide-area network (WAN), the Internet, or the like, and may include private or public network systems. In an embodiment, the network 130 comprises a virtual private network (VPN) that allows users access to a secure private network using the Internet. It should be noted that the communications links are illustrated as a wired communications link for illustrative purposes only, and may include either a wired link and/or a wireless link.

The server 134 is an optional device that may be used to provide a central location for documents and/or to provide secure access to the proceedings. The server 134 may be any general purpose computing device, such as a personal computer (PC), a mini-computer, a main frame, a personal data assistant, a laptop computer, a tablet PC, or the like.

Each of the remote devices 132 may comprise a general purpose computing device, such as a personal computer (PC), a mini-computer, a main frame, a personal data assistant, a laptop computer, a tablet PC, or the like configured to communicatively couple to the network 130.

The video imaging system 124 generates an electronic video image for the purpose of transmitting the video image to the remote systems 132. Additionally, it is preferred that the video imaging system 124 have the ability to record the video images for later viewing, such as may be the case when a deponent is unable to testify at a later date, when a user wishes to review the testimony, or the like.

Optionally, a document imaging system 126 may be communicatively coupled to the video imaging system 124 and the control system 112. Generally, the document imaging system 126 creates an electronic image of a physical exhibit, such as a text book, and transmits the electronic image to the video imaging system 124. The electronic image of the physical exhibit may then be transmitted to the remote systems 132 via the connection between the video imaging system 124 and the control system 112. A document imaging system that may be used in an embodiment of the present invention is the Elmo HV-5100XG Visual Presenter manufactured by ELMO USA of Plainview, N.Y.

The operation of an embodiment of the present invention described above is described in the following paragraphs in the context of a deposition. Other embodiments of the present invention, however, may also be applied to other situations, such as conducting interviews, examinations, or any other situation in which it would be useful for a plurality of individuals to witness and/or partake in the questioning of and/or discussion with one or more individuals.

During a deposition, it is expected that a questioner (e.g., the attorney taking the deposition) will be positioned at the control system 112, and a deponent will be positioned at the document-viewing system 114. The questioner may select a document that is to be displayed to the deponent via the document-viewing system 114. The document may be stored locally (e.g., on a hard drive, in memory, on a removable storage medium, or the like) or may be stored remotely on, for example, the server 134 or other remote storage devices. The document may also be stored on a removable storage device accessible by the control system 112.

After the document has been selected by the questioner, the questioner is able to cause the control system 112 to display the document on the document-viewing system 114 and/or the remote systems 132. The deponent and/or the questioner may navigate the document by scrolling up, down, left, or right to examine the entire document. Preferably, navigation by one of the users (e.g., the deponent, the questioner, or a remote user) is reflected in the display of the other users. In this manner, it is possible for two or more users to simultaneously view and follow the discussion of specific portions of a document.

It is also preferred that the questioner, the deponent, and/or a remote user have the ability to mark or identify one or more portions of the document. Marking may be performed by, for example, highlighting, underlining, bolding, italicizing, or the like specific portions of the document using the indicator devices 120 (e.g., a mouse). For example, the questioner may highlight a section of the document that the questioner would like the deponent to review. The sections highlighted by the questioner are preferably displayed on the document-viewing system 114 and the remote systems 132. Similarly, the deponent may highlight sections of the document on the document-viewing system 114 which in turn are shown on the control system 112 and the remote systems 132, and a remote user may highlight sections of the document on the remote system 132 which in turn are shown on the control system 112 and the document-viewing system 114. Additionally, the document may be stamped for purposes of identifying at a later date.

One skilled in the art will appreciate that embodiments of the present invention can be used to electronically view documents and identify specific portions of the document. Moreover, the audio-receiving devices 122 and the video imaging systems 124 allow the remote users to view and hear the proceedings via the remote systems 132. This allows the remote users the ability to simultaneously see the demeanor of the witness, hear the tone of the witness' voice, and view the specific portions of the document being discussed. Thus, embodiments of the present invention may be utilized to allow remote users to view the proceedings, including the documents being discussed, from a remote location and to provide additional information and/or questions to the questioner.

Embodiments of the present invention can further provide the ability for the questioner to communicate with one or more remote users. Preferably, the control system 112 and the remote systems 132 are configured to provide substantially real-time, two-way communications. One mechanism that has been found to be useful in providing this ability is Instant Messaging (IM). IM is a communications tool that provides two-way textual communications between computer systems coupled to a network and allows a plurality of parties to participate in a single conversation. In this case, an IM session may be established between the control system 112 and one or more remote systems 132. The IM sessions may be used by the questioner to request additional information from the remote users and/or by the remote users to communicate questions and information to the questioner. It should be noted, however, that it is preferred that the IM session not be available to the deponent on the document-viewing system 114.

Optionally, audio-receiving devices and/or video imaging systems may be located at one or more of the remote locations, thereby allowing for two-way audio and video communications between the remote users and the questioner/deponent. This embodiment may be particularly useful in situations in which a remote user will be directly questioning the deponent.

As the deposition proceeds, the text of the deposition can be recorded by a court reporter using the stenography system 116. Preferably, the text of the deposition is provided real-time to the questioner and/or the remote users via the control system 112 and the remote systems 132, respectively. In this manner, the questioner and the remote users can review the questions and answers and pose follow-up questions in situations in which the record is not clear.

As one skilled in the art will appreciate, the proceedings of the deposition may be recorded for review at a later time. The recordings of the proceedings may include a transcription of the deposition proceedings as provided by the stenography system 116, the video from the video imaging system 124, documents presented and marked via the document-viewing system 114, documents presented via the document imaging system 126, voice recordings from the audio-receiving devices 122, and/or the like.

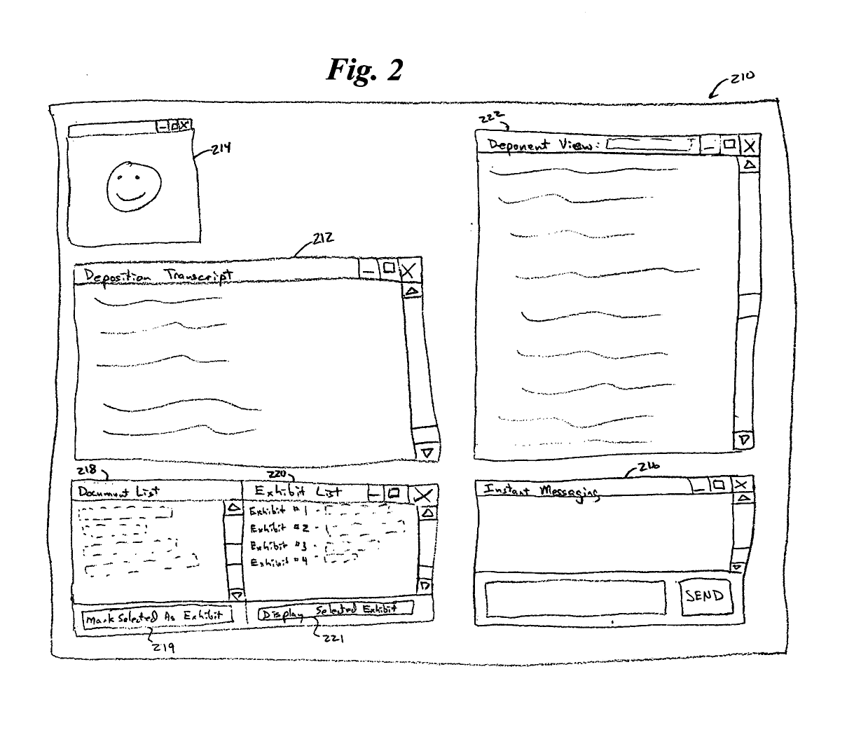

Referring now to FIG. 2, a screen 210 is shown that can be presented to the questioner in an embodiment of the present invention. The screen discussed below corresponds to the embodiment discussed above in which the present invention is being used in the context of a deposition. Other screen layouts and designs may be used.

The screen 210 includes a deposition transcript section 212, a video section 214, an instant messaging section 216, a document list section 218, an exhibit list section 220, and a deponent view 222. The deposition transcript section 212 displays the text of the deposition, preferably real-time as the stenographer transcribes the discussion between the questioner and the deponent. The text of the deposition preferably scrolls as the deposition proceeds such that the most recent text is displayed. A user (e.g., a questioner or a remote user) can use the scroll controls along the right side of the deposition transcript section 212 to access text from earlier portions of the deposition.

The video section 214 provides a view of the video being transmitted by the video imaging device 124. This allows the questioner to view the image being sent to the remote systems 132 and/or being recorded. If the image is unacceptable, the questioner can adjust the video imaging system to obtain a satisfactory image.

The instant messaging section 216 provides two-way communications between the questioner and remote users.

The document list section 218 provides a list of documents available to the questioner. In a preferred embodiment, the document list section 218 provides capabilities similar to Windows Explorer utility provided with Microsoft Windows, which is manufactured by Microsoft Corporation, of Redmond, Wash. The document list section 218 preferably provides searching capabilities and access to any files stored locally (e.g., on the control system 112), remotely (e.g., on the server 134 or the remote systems 132), or on a removable storage device (e.g., a CD, DVD, memory card, external hard drive, or the like). After the desired document has been located, the selected file may be marked as an exhibit and added to the exhibit list section 220 by, for example, selecting the “Mark Selected As Exhibit” button 219. A drag-and-drop mechanism can also be used to mark a document as an exhibit and make the document available for display on the document-viewing system 114.

The exhibit list section 220 comprises a list of documents that have been produced as exhibits during the course of the deposition. Similar to the document list section 218 discussed above, it is preferred that the exhibit list section 220 provide capabilities similar to Windows Explorer, including a searching capability. A document in the exhibit list section 220 can be displayed to the deponent by selecting a document and then selecting the “Display Selected Exhibit” button 221.

After a document has been selected to be displayed to the deponent, the deponent view section 222 is updated accordingly. In an embodiment, the text displayed in the deponent view section 222 mirrors the text being displayed to the deponent on the document-viewing system 114. Scroll bars along the right side of the window may be used to scroll within the document and, preferably, may be controlled by either of the indicator devices 120.

It should be noted that it may be desirable to prioritize the ability of the participants to control the scrolling of the document in the deponent view 222. For example, as discussed above, the deponent, the questioner, and the remote users may have the ability to scroll through the current document. It may be desirable to allow the questioner to override the movement of the deponent and/or the remote users, and to allow the remote users to override the movement of the deponent. A different priority ranking may be used.

A screen similar to the screen 210 may be presented by the remote systems 132. A screen displayed by the document-viewing system 114, however, preferably only contains the text displayed in the deponent view 222.

It should be noted that each of the views are preferably presented as separate windows having minimize and maximize buttons. This allows the questioner the greatest flexibility in organizing the display in such a manner that best suits the questioner at any given point in the deposition. For example, if a specific document is being discussed, the examiner may wish to maximize the deponent view 222 such that more of the document may be viewed by the questioner. As another example, if the questioner wishes to look back over the deposition transcript, the questioner may wish to maximize the deposition transcript window such that more of the deposition transcript is viewable by the questioner.

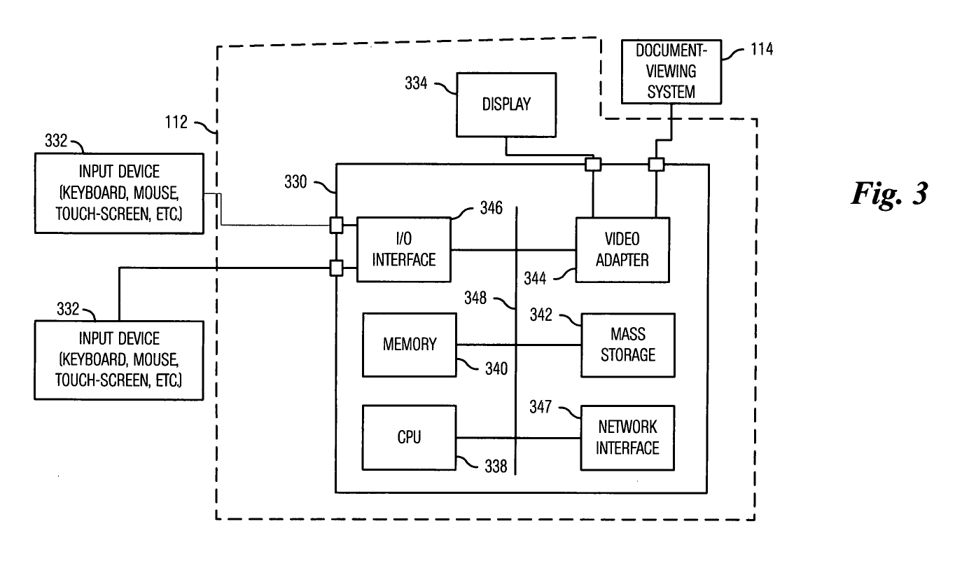

FIG. 3 is a block diagram of the control system 112 in accordance with an embodiment of the present invention. Generally, the control system 112 may comprise a processing unit 330 equipped with one or more input devices 332 (e.g., a mouse, a keyboard, or the like), and one or more output devices, such as a display 334, or the like. The processing unit 330 may be, for example, a desktop computer, a workstation, a laptop computer, a personal digital assistant, a dedicated unit customized for a particular application, or the like. The processing unit 330 and the display 334 may be integrated into a single unit such as a laptop computer.

Generally, the processing unit 330 includes a central processing unit (CPU) 338, memory 340, a mass storage device 342, a video adapter 344, and an I/O interface 346 connected to a bus 348. The bus 348 may be one or more of any type of several bus architectures including a memory bus or memory controller, a peripheral bus, video bus, or the like. The CPU 338 may comprise any type of electronic data processor. For example, the CPU 338 may comprise a Pentium™ processor from Intel Corp., an Athlon processor from Advanced Micro Devices, Inc., a Reduced Instruction Set Computer (RISC), a Complex Instruction Set Computer (CISC), Application-Specific Integrated Circuit (ASIC), or the like. The memory 340 may comprise any type of system memory such as static random access memory (SRAM), dynamic random access memory (DRAM), synchronous DRAM (SDRAM), read-only memory (ROM), double data rate random access memory (DDR RAM), a combination thereof, or the like. In an embodiment, the memory 340 may include ROM for use at boot-up, and DRAM for data storage for use while executing programs.

The mass storage device 342 may comprise any type of storage device configured to store data, programs, and other information and to make the data, programs, and other information accessible via the bus 348. In a preferred embodiment, the mass storage device 342 is configured to store the computer software programs to be executed by the CPU 338. The mass storage device 342 may comprise, for example, one or more of a hard disk drive, a magnetic disk drive, an optical disk drive, solid state memories (e.g., flash and universal serial bus (USB) memory keys), or the like.

The video adapter 344 and the I/O interface 346 provide interfaces to couple external input and output devices to the processing unit 330. As illustrated in FIG. 3, examples of input and output devices include the display 334 coupled to the video adapter 344 and the mouse/keyboard 332 coupled to the I/O interface 346. It should be noted that the video adapter 344 is illustrated as driving two displays (display 334 and the display of the document-viewing system 114). In this embodiment, the document-viewing system 114 comprises a display and the video adapter 344 is capable of independently driving two separate displays. In another embodiment, the document-viewing system 114 may include processing capability and the processing unit 330 transmits information with which the document-viewing system 114 generates its own display. Other devices may be coupled to the processing unit 330.

The processing unit 330 may also include a network interface 347. The network interface 347 allows the processing unit 330 to communicate with remote units via a network (not shown). In an embodiment, the processing unit 330 is coupled to a local-area network or a wide-area network to provide communications to remote devices, such as other processing units, the Internet, or the like. The network interface 347 may provide an interface for a wired link, such as an Ethernet cable or the like, or a wireless link.

It should be noted that the control system 112 can include other components. For example, the control system 112 can include power supplies, cables, a motherboard, removable storage media, cases, and the like. These other components, although not shown, are considered part of the control system 112.

It should also be noted that all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise. In other embodiments, a hardware system may be specifically designed to perform one or more of the functions described herein.

Although embodiments of the present invention and at least some of its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of providing remote examination services, the method comprising:
communicatively coupling a first network device to a network;
communicatively coupling a first display and a second display to the first network device such that the first network device may display information on the first display and the second display;
communicatively coupling a video imaging system to the first network device such that the first network device may transmit video from the video imaging system over the network;
communicatively coupling an audio-receiving device to the first network device such that the first network device may transmit audio from the audio-receiving device over the network;
communicatively coupling a second network device to the network, the second network device being located at a remote location from the first network device, the second network device including a third display;
selecting a document to view;
displaying the document on at least the first display and the second display;
transmitting audio detected by the audio-receiving device to the second network device; and
transmitting video from the video imaging system to the second network device.

2. The method of claim 1, further comprising:
communicatively coupling a first indicator and a second indicator to the first network device; and
allowing a user to identify one or more portions of the document using the first indicator and the second indicator, wherein the portions are visually identified on the first display, the second display, and the third display.

3. The method of claim 1, further comprising:
communicatively coupling an indicator to the second network device;
allowing a user to identify one or more portions of the document using the indicator, wherein the portions are visually identified on the first display, the second display, and the third display.

4. The method of claim 1, wherein the document is stored on a server communicatively coupled to the network.

5. The method of claim 1, wherein the network is secure.

6. The method of claim 1, further comprising providing two-way textual communications between the first network device and the second network device via the network.

7. The method of claim 1, further comprising communicatively coupling a stenography system to the network and transmitting a transcription to the second network device.

8. A system for providing remote examination services, the system comprising:
a first display;
a second display;
a video imaging system to generate video signals;
an audio-receiving device to generate audio signals;
a remote network device communicatively coupled to a network, the remote network device having a third display; and
a local network device communicatively coupled to the first display, the second display, the video imaging system, and the audio-receiving device, the local network device being communicatively coupled to the network and being configured to display a selected document on the first display and the second display, the local network device being configured to transmit to the remote network device the audio signals, the video signals, and an image presented on the first display.

9. The system of claim 8, further comprising a first indicator and a second indicator communicatively coupled to the local network device, wherein the local network device is configured to allow a user to identify one or more portions of the selected document using the first indicator and the second indicator, the portions being visually identified on the first display, the second display, and the third display.

10. The system of claim 8, further comprising an indicator communicatively coupled to the remote network device, the remote network device being configured to allow a user to identify one or more portions of the selected document using the indicator, the portions being visually identified on the first display, the second display, and the third display.

11. The system of claim 8, wherein the selected document is stored on a server communicatively coupled to the network.

12. The system of claim 8, wherein the network is secure.

13. The system of claim 8, wherein the local network device and the remote network device are configured to provide two-way textual communications between the local network device and the remote network device via the network.

14. The method of claim 8, further comprising a stenography system communicatively coupled to the network, the stenography system being configured to transmit a transcription to the remote network device via the network.

15. A method of performing a remote examination, the method comprising:
communicatively coupling a first network device to a network;
generating by a video imaging system a first video image of a deponent, the video imaging system being communicatively coupled to the first network device;
generating by a document viewing system a second video image of a physical exhibit, the document viewing system being communicatively coupled to the first network device; and
transmitting the first video image and the second video image to a second network device, the second network device being communicatively coupled to the network.

16. The method of claim 15, further comprising communicatively coupling an audio-receiving device to the first network device and transmitting audio signals to the second network device.

17. The method of claim 15, further comprising communicatively coupling a stenography system to the first network device and transmitting a transcription to the second network device.

18. The method of claim 15, further comprising:
communicatively coupling a first display and a second display to the first network device;
displaying information on the first display and the second display; and
transmitting the information to the second network device via the network.

19. The method of claim 15, further comprising providing two-way textual communications between the first network device and the second network device via the network.

20. The method of claim 15, wherein the network is secure.
